(19) United States
(12) Patent Application Publication
(10) Pub. No.: US 2026/0347260 A1
(43) Pub. Date: Nov. 5, 2026

(54) LIGHTWEIGHT HIGH-STRENGTH GYPSUM BOARD

(71) Applicant: Georgia-Pacific Gypsum LLC, Atlanta, GA (US)

(72) Inventors: Richard David Jordan, Decatur, GA (US); Hamed Mustafa Kayello, Peachtree Corners, GA (US); Sudhanshu Srivastava, Decatur, GA (US); Vincent B. Thomas, Bogart, GA (US)

(21) Appl. No.: 19/118,790

(22) PCT Filed: Oct. 23, 2023
(86) PCT No.: PCT/IB2023/060683

§ 371 Date: Apr. 7, 2025

Related U.S. Application Data
(60) Provisional application No. 63/419,349, filed on Oct. 26, 2022.

(51) Int. Cl. C04B 28/14; B32B 5/18; B32B 13/14; C04B 14/42; C04B 16/06; C04B 111/00; E04C 2/04

(52) U.S. Cl. CPC C04B 28/14; B32B 5/18; B32B 13/14; C04B 14/42; C04B 16/0633; E04C 2/043; B32B 2262/0253; B32B 2262/0261; B32B 2266/049; B32B 2607/00; C04B 2111/0062

(57) ABSTRACT

Systems and methods for manufacturing a lightweight high strength gypsum board are provided. The lightweight high strength gypsum board includes a gypsum layer formed from a gypsum slurry, where the gypsum layer has a bottom and a top. The gypsum slurry comprises a polymeric foam and optionally a soap solution. The gypsum board further includes a first mat placed on the bottom of the gypsum layer, and a second mat placed on the top of the gypsum layer. The gypsum slurry may optionally comprise reinforced fibers.

### CROSS-REFERENCE TO RELATED APPLICATION

This application claims the benefit of U.S. Provisional Application No. 63/419,349, filed Oct. 26, 2022, and entitled “LIGHTWEIGHT HIGH-STRENGTH GYPSUM BOARD,” which is incorporated by reference herein in its entirety.

### BACKGROUND

The present invention generally relates to the field of gypsum board products, and more specifically to a lightweight high-strength gypsum board having a polymeric foam core and reinforced fibers.

Building panels, such as interior wallboard, building sheathing, or roof panels include a core material, such as gypsum. Building panels also include a mat facer, such as a fiberglass mat or paper facer. During manufacturing, the gypsum core material may be applied as a slurry to a surface of the glass mat or paper facer and allowed to set, such that the mat facer and gypsum core are adhered at the interface. The Applicants have identified several performance issues that may result from the manufacture of building panels.

Through applied effort, ingenuity, and innovation, the Applicants have solved problems relating to lightweight high-strength gypsum board by developing solutions embodied in the present disclosure, which are described in detail below.

### SUMMARY

According to one embodiment of the present disclosure, a high strength light weight gypsum board having a polymer foam core is provided. The gypsum board includes a gypsum layer formed from a gypsum slurry, where the gypsum layer has a bottom and a top. The gypsum slurry includes a polymeric foam. The gypsum board further includes a first mat placed on the bottom of the gypsum layer, and a second mat placed on the top of the gypsum layer. The gypsum slurry optionally includes a soap solution, where the polymeric foam and soap solution are in a predetermined mix ratio.

According to one embodiment of the present disclosure, a slate coat layer may be present between the gypsum core and the top or bottom layer. The gypsum board includes a gypsum layer formed from a gypsum slurry, where the gypsum layer has a bottom and a top. The gypsum slurry includes a polymeric foam. The gypsum board further includes a first mat placed on the bottom of the gypsum layer, and a second mat placed on the top of the gypsum layer. The slate coat layer is a dense gypsum layer which is present between the mat (first or second) and the gypsum core. Slate coat can be present at least on one side of the board. The gypsum slurry or core optionally includes a soap solution, where the polymeric foam and soap solution are in a predetermined mix ratio.

According to yet another embodiment of the present disclosure, a method of manufacturing a high strength light weight gypsum board is provided. The method includes forming a gypsum layer from a gypsum slurry, where the gypsum layer has a bottom and a top. The gypsum slurry includes a polymeric foam. The method further includes positioning a first mat on the bottom of the gypsum layer and positioning a second mat on the top of the gypsum layer. The gypsum slurry optionally includes a soap solution, where the polymeric foam and soap solution are in a predetermined mix ratio.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a cross-sectional view of an example gypsum panel, according to various embodiments;

FIG. 2 is a cross-sectional view of an example gypsum panel, according to various embodiments;

FIG. 3 depicts a schematic representation of an example gypsum core with a polymeric foam, according to various embodiments;

FIGS. 4A-4D depict cross-sectional views of an example gypsum panel, according to various embodiments;

FIG. 5A depicts example foam, according to various embodiments;

FIG. 5B is a chart depicting foam stability for various foam to soap ratio, according to various embodiments;

FIG. 6A is a chart depicting comparison of compression test results, according to various embodiments;

FIG. 6B is a chart depicting comparison of push through test results, according to various embodiments;

FIG. 7A is a chart depicting comparison of pull through test results, according to various embodiments;

FIG. 7B is a chart depicting comparison of flexural test results, according to various embodiments;

FIGS. 8A and 8B depict a reduction in dust upon cutting boards manufactured in accordance with embodiments herein; and

FIG. 9 is a chart depicting comparison of nail pull results for boards having reinforced fibers, according to various embodiments.

### DETAILED DESCRIPTION

The invention is described in detail below with reference to the figures for purposes of illustration only. Modification to various embodiments illustrated within the spirit and scope of the present invention will be readily apparent to one of skill in the art.

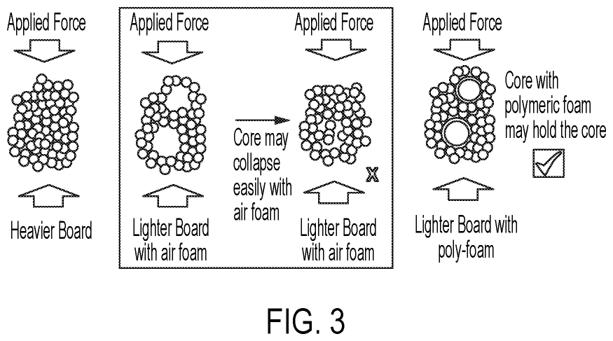

Embodiments herein provide for a gypsum core having a polymeric foam incorporated therein that results in a lighter weight core and a stronger gypsum core due at least in part to bubbles formed from the incorporation of the polymeric foam. FIG. 3 depicts a schematic representation of an example gypsum core with a polymeric foam, according to various embodiments. In FIG. 3, a polymeric foam is incorporated into the gypsum core to provide more structural integrity in the gypsum core. That is, the polymeric foam introduces bubbles within the foam and the bubbles, as a result of being reinforced by poly-foam (as opposed to merely air foam), provide for increased resistance to applied force to the gypsum core. The polymer foam further provides better adhesion and structural integrity to the gypsum core. In embodiments, the polymer may be styrene butadiene co-polymer, which can be mixed at different ratios with foaming agents. In some embodiments, the polymeric foam may be poly-vinyl alcohol, acrylonitrile butadiene styrene, other foamable polymers, or air bubbles, such as polymeric microspheres or hollow glass bubbles. According to various embodiments, the styrene butadiene co-polymer exhibits a range of styrene:butadiene mole ratios.

Embodiments herein further provide for gypsum panels or boards having the improved gypsum core as described above as well as reinforced fibers integrated into the gypsum core, or integrated into one or more fibrous mats of the gypsum panels or boards. In some embodiments, the reinforced fibers are introduced on top of existing glass fibers or replacing glass fibers. Examples of the reinforced fibers include polyamide fibers, polyimide fibers, cellulose fibers, polypropylene or polyethylene fibers, hemp fibers, polyvinyl alcohol fibers, carbon fibers, glass fibers, different glass fiber types like A, E, C, AE or S, basalt fibers and the like.

Embodiments herein, including the polymer foam in the gypsum core as well as the reinforced fibers, result in gypsum boards having a reduction in weight of ~20% by mass and similar or better strength properties. In certain embodiments, the weight reduction may be in a range of approximately 10% to 30%; in other embodiments, the range may be between 15% and 25%. For example, a board range of 2000 to 2500 lb/msf can be made ~20% lighter to 1600 to 1920 lbs/msf. Or in another scenario a board with 1450 to 1650 lbs/msf can be made ~20% lighter to 1160 to 1320 lbs/msf.

The weight reduction percentage for making lighter boards also allows manufacturers to use less raw material and thereby enable a faster line speed and/or drying, which may save energy. The lighter products will also allow easier on-site installation and facilitate the transfer of boards to a site. This further improves sustainability in manufacturing.

In some embodiments, the gypsum panels or boards may contain a set gypsum core place between (or “sandwiched”) between two mats, one or both of which may be coated with a mat coating. In some embodiments, the mat coating is a substantially continuous barrier coating, which, a used herein, refers to a coating material that is substantially uninterrupted (i.e., substantially contiguous) over the surface of the mat. In some embodiments, the mat coating is a porous material configured to allow for the escape (e.g., via evaporation) from the gypsum panels or boards.

In some embodiments, during manufacturing, a gypsum slurry is deposited on the uncoated surface of a facer material, such as a paper sheet or fiberglass mat (which may be pre-coated prior to manufacturing) and set to form a gypsum core of the gypsum panel. In some embodiments, the gypsum slurry penetrates some portion of the thickness of the fiberglass mat or paper sheet and in at least this way provides a mechanical bond for the panel. The gypsum slurry containing binder, such as starch, may form a chemical hydrogen bond with paper facing material. The gypsum slurry may be provided in one or more layers, having the same or different compositions, including one or more slate coat layers. As used herein, the term “slate coat” refers to a gypsum slurry having a higher wet density than the remainder of the gypsum slurry that forms the gypsum core.

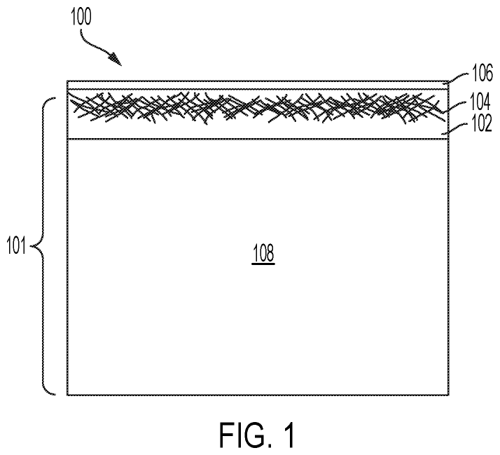

In certain embodiments, as shown in FIG. 1, a gypsum panel 100 includes a gypsum core 101 having a first surface and a second opposed surface, and a first facer material 104 (shown here as a fibrous mat, but it will be appreciated that facer materials described herein may be paper facers or other suitable material) associated with the first surface of the gypsum core 101, such that gypsum of the gypsum core penetrates at least a portion of the first mat 104. The various layers are illustrated as separate layers in the figures for ease of illustration; however, it should be understood that overlap of these materials may occur at their interfaces. In certain embodiments, the gypsum panel 100 includes a set gypsum core 101 associated with a first surface of first fibrous mat 104 and an optional mat coating 106 applied to a second surface of the first fibrous mat 104.

In some embodiments, as shown in FIG. 1, the slurry (e.g., gypsum containing hydrophobic additive such as siloxane) of the gypsum core 101 penetrates a remaining portion of the first fibrous mat 104 such that voids in the mat 104 are substantially eliminated and the water resistance of the panel 100 is further enhanced. For example, in one embodiment, the first mat 104 has a mat coating 106 on a surface opposite the gypsum core 101, the mat coating 106 penetrating a portion of the first mat 104, to define the remaining portion of the first mat 104. That is, gypsum of the gypsum core 101 may penetrate a remaining fibrous portion of the first fibrous mat 104 such that voids in the first mat 104 are substantially eliminated. In certain embodiments, the mat 104 is a nonwoven fiberglass mat. In various embodiments, the gypsum board can have glass mats as top and bottom surfaces or can be paper sheets as top and bottom surfaces.

In certain embodiments, as shown in FIG. 1, the gypsum core 101 includes two or more gypsum layers 102, 108. For example, the gypsum core may include various gypsum layers having different compositions. Like 102 can be denser like a slate coat compared to the 108 layer.

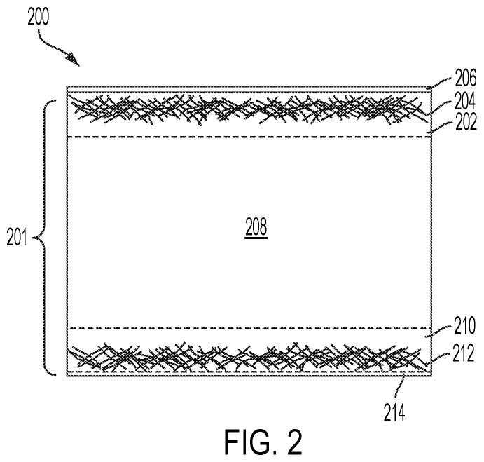

In certain embodiments, as shown in FIG. 2, a gypsum panel 200 includes two fibrous mats 204, 212 that are associated with the gypsum core 201. The second mat 212 is present on a face of the gypsum core 201 opposite the first mat 204. In some embodiments, only the first mat 204 has a mat coating 206 on a surface thereof. In other embodiments, both mats 204, 212 have a coating 206, 214 on a surface thereof opposite the gypsum core 201. In some embodiments, the gypsum core 201 includes three gypsum layers 202, 208, 210.

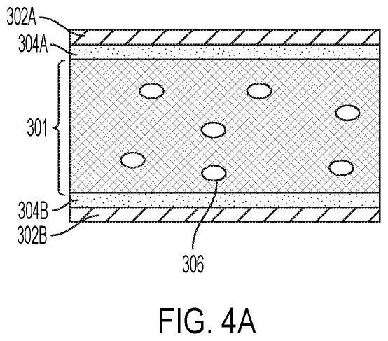

FIGS. 4A-4D depict cross-sectional views of an example gypsum panel 300. In some embodiments, the example gypsum panel 300 may include a gypsum core 301. In some embodiments, the example gypsum panel 300 may include one or more may layers 302A, 302B. In some embodiments, the gypsum panel 300 may include one or more coats 304A, 304B. In some embodiments, the gypsum panel 300 may include a plurality of additives 306. In some embodiments, as shown in at least FIG. 4B, a polymeric layer 308 may be disposed as a layer around the additives 306 or around an empty core 314. In some embodiments, as shown in at least FIGS. 4C and 4D, the gypsum panel 300 may include one or more reinforced fibers 310. In some embodiments, the gypsum core 301 may include a polymer material 312.

In various embodiments, the gypsum core comprises a polymeric foam and optionally a soap solution. References herein to a soap solution refer to foaming agent surfactants used in the gypsum industry to generate foam in gypsum panels. For example, an anionic or amphoteric surfactant may be used in some embodiments. Example anionic surfactants include (but are not limited to) Hyonic® foaming agents from GEO, Cedepal® foaming agents from Stepan Company, Alpha Foamer® G available from the Stepan Company and Enafoam WB 5 available from the Enaspol Company. In various embodiments, the gypsum core is made from a gypsum slurry comprising a polymeric foam (e.g., from 3 to 50% in water) and a soap solution (e.g., 0.1 to 5% in water) in a 1:1 ratio. In some embodiments, the gypsum slurry can comprise polymeric foam and soap solution in a weight ratio from ≥0.1:1 to ≤10:1 (for example ≥0.2:1 to ≤5:1, or ≥0.5:1 to ≤2:1). The polymeric foam and soap solution can be pre-mixed and foamed prior to being mixed into the gypsum slurry to provide a foamed gypsum slurry. The polymeric foam and soap can also be added simultaneously to gypsum slurry and foamed in situ (e.g. slurry mixer) to provide a foamed gypsum slurry. In some of these embodiments, reinforced fibers (e.g., 310, as shown in at least FIGS. 4C and 4D), including polyamide fibers or glass fibers or combinations (e.g., 1-15 lbs/msf) can be incorporated.

In various embodiments, the gypsum core is made from a gypsum slurry comprising a polymeric foam and a soap solution in a 3:1 ratio. In some of these embodiments, reinforced fibers, including polyamide fibers or glass fibers or combinations (e.g., 1-32 lbs/msf, 1-24 lbs/msf, 1-15 lbs/msf, or 1-12 lbs/msf) can be incorporated.

In various embodiments, the gypsum core is made from a gypsum slurry comprising a polymeric foam and a soap solution in a 1:1 ratio. In some of these embodiments, reinforced fibers, including polypropylene fibers or glass fibers or combinations (e.g., 1-15 lbs/msf) can be incorporated.

In various embodiments, the gypsum core is made from a gypsum slurry comprising a polymeric foam and a soap solution in a 3:1 ratio. In some of these embodiments, reinforced fibers, including polypropylene fibers or glass fibers or combinations (e.g., 1-15 lbs/msf) can be incorporated.

While ratios of 1:1 and 3:1 have been identified herein-above, it should be understood that a range of ratios approximate these values may also be utilized, without departing from the scope and intent of the present invention.

Other possible combinations for foaming may not be limited to 2 components, like soap and polymeric foam, but may also have combinations of 2 or more polymeric foam systems (like styrene-butadiene co-polymer with polyvinyl alcohol) at different ratios with or without soap solution. For example, other possible combination can be just the polymeric foam with or without soap solution added, further combined with reinforced fibers. Based upon the rate of addition to generate polymeric foam, different ratios in varying amounts can be incorporated in the core which can range from 0.05 to 15 lbs/msf of polymer added to the core.

In various embodiments, a polymer matrix or network can be incorporated in the gypsum core or gypsum layer, either directly onto the gypsum core or on top of reinforced fibers on the gypsum core. The polymer matrix provides further improved adhesion of gypsum molecules and increased strength properties.

In various embodiments, a polymer matrix can be incorporated in the gypsum core or gypsum layer added on top of the polymeric foam and reinforced fibers.

The polymer added on top of the polymeric foam can be same type or different and can be added in any ratio compared to the foam.

In some of these embodiments, the gypsum core is made according to embodiments herein and a polymer matrix (e.g., Lipaton 8100; e.g., up to 10 lbs/msf; up to 32 lbs/msf) as well as polyamide fibers (e.g., 1-15 lbs/msf) are incorporated.

In some of these embodiments, the gypsum core is made according to embodiments herein and a polymer matrix (e.g., Lipaton 8100; e.g., up to 10 lbs/msf; up to 32 lbs/msf) as well as polypropylene fibers (e.g., 1-15 lbs/msf) are incorporated.

In some of these embodiments, the gypsum core is made according to embodiments herein and a polymer matrix (e.g., Lipaton 8100; e.g., up to 10 lbs/msf; up to 32 lbs/msf) as well as cellulose fibers (e.g., 1-15 lbs/msf) are incorporated.

In some of these embodiments, a gypsum board was prepared with slate coat layer incorporated between the glass mat and the core. Polymeric foam using Lipaton 8100 (10% diluted solution) was mixed with soap solution in 1:1 ratio. Also, for reinforcing glass fibers were added up to 9 lbs/msf. The boards made were 20% lighter compared to the control. The outer layers were coated glass mats.

In some of these embodiments, a gypsum board may include a slate coat layer incorporated between the glass mat and the core having outer layers of coated glass mats. In some embodiments, polymeric foam using Lipaton 8100 (10% diluted solution) may be mixed with soap solution in 1:1 ratio. In some embodiments, at least for purposes of reinforcement, polypropylene fibers may be added, such as up to 9 lbs/msf. In some embodiments, the boards constructed according to these described specifications made were 20% lighter compared to control boards. In certain combinations polymeric foam was prepared via polyvinyl alcohol (5% diluted solution) was mixed with soap solution in 1:1 ratio.

A table representing the data collected for different formulations is shown below and presents the advantage of the lighter board with polymeric foam and fibers compared with a lightweight control board:

| | Flexural | Pull | Humid | | Cube |
|---|---|---|---|---|---|
| | (Average) | Through | Bond | Moisture | Compression |
| Formulations | (lbf) | (lbf) | (lbf) | (% Abs) | (lbf) |
| Control | 147 | 210 | 18.2 | 2.5 | ~2035 |
| Light Weight | 87 | 131 | 11.5 | 4.1 | ~1264 |
| (LW) | | | | | |
| Control | | | | | |
| LW with | 151 | 205 | 19.2 | 2.6 | ~2000 |
| Lipaton | | | | | |
| foam + | | | | | |
| Reinforced | | | | | |
| Glass Fibers | | | | | |
| LW with | 141 | 201 | 18.8 | 3.1 | N/A |
| Lipaton | | | | | |
| Foam + | | | | | |
| Reinforced | | | | | |
| Glass | | | | | |
| Fibers + | | | | | |
| Polypro- | | | | | |
| pylene | | | | | |
| Fibers | | | | | |
| LW with | 152 | 235 | 20.1 | 2.8 | N/A |
| Lipaton | | | | | |
| Foam + | | | | | |
| Glass | | | | | |
| Fibers + | | | | | |
| Polymer | | | | | |
| Matrix | | | | | |
| LW with | N/A | 181 | 13.4 | 2.0 | ~1592 |
| Polyfoam, | | | | | |
| no Fibers | | | | | |

To compare the strength of the core cube compression testing was also performed. Samples (cubes prepared as 2-inch cubes in a mold sans facer mats) were dry tested for compression, and cubes made with polymeric foam and reinforced fibers gave better strength properties compared to the cubes made with only soap solution as light weight control (as shown in the table above).

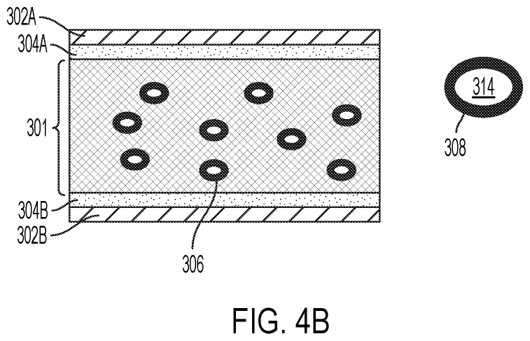

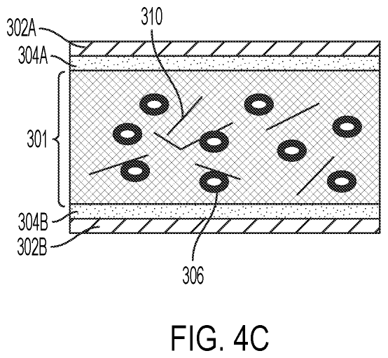

FIG. 5A depicts example foam, according to various embodiments. FIG. 5B is a chart depicting foam stability for various foam to soap ratio, according to various embodiments. In FIG. 5A, Lipaton 8100 is foamed according to different ratios with a soap solution, and FIG. 5B shows the resulting stabilities.

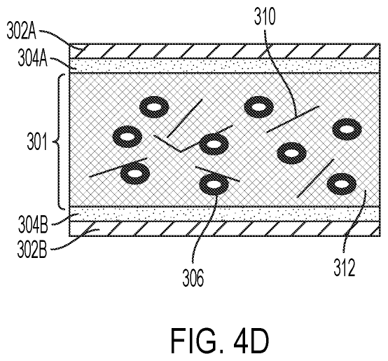

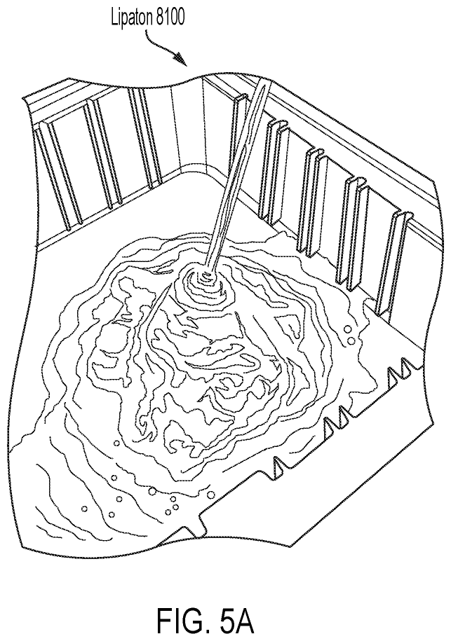

FIG. 6A is a chart depicting comparison of compression test results, according to various embodiments. In FIG. 6A, a gypsum board without the polymer foam in the gypsum core and without reinforced fibers (e.g., Control in FIG. 6A) was compared to a gypsum board with double foam levels (e.g., Control with 2× Foam in FIG. 6A), as well as a gypsum board having polymer foam (with a 1:1 soap to polymer ratio) and reinforced fibers (e.g., 1:1 Foam+Fiber in FIG. 6A) and a gypsum board having polymer foam (with a 1:3 soap to polymer ratio) and reinforced fibers (e.g., 1:3 Foam+Fiber in FIG. 6A). The gypsum boards having polymer foam and reinforced fibers showed a reduction in weight and comparable strength properties as the Control in FIG. 6A.

FIG. 6B is a chart depicting comparison of push through test results, according to various embodiments. In FIG. 6B, a gypsum board without the polymer foam in the gypsum core and without reinforced fibers (e.g., Control in FIG. 6B) was compared to a gypsum board having polymer foam (with a 1:1 soap to polymer ratio) and reinforced fibers (e.g., 1:1 Foam+Fiber in FIG. 6B) and a gypsum board having polymer foam (with a 1:3 soap to polymer ratio) and reinforced fibers (e.g., 1:3 Foam+Fiber in FIG. 6B). The gypsum boards having polymer foam and reinforced fibers showed a reduction in weight and comparable strength properties as the Control in FIG. 6B.

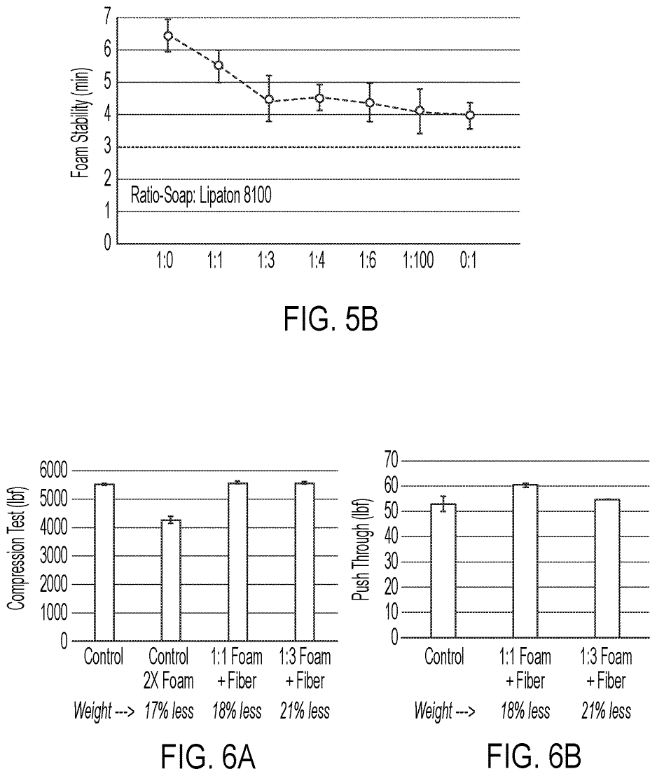

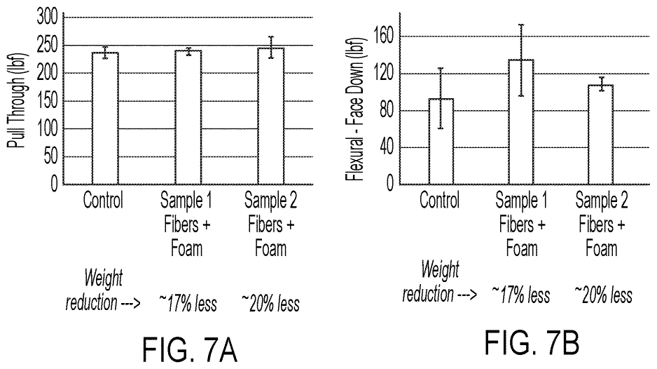

FIG. 7A is a chart depicting comparison of pull through test results, according to various embodiments. FIG. 7B is a chart depicting comparison of flexural test results, according to various embodiments. For the results in FIGS. 7A and 6B, gypsum boards of different dimensions (e.g., Sample 1 is 14×14 inch, Sample 2 is 12×16 inch) were prepared having both the polymer foam in the gypsum core as well as the reinforced polypropylene fibers. Both samples delivered weight reduction as well as an increase in strength as compared to a gypsum board without the polymer foam and reinforced fibers (e.g., Control in FIGS. 7A and 7B).

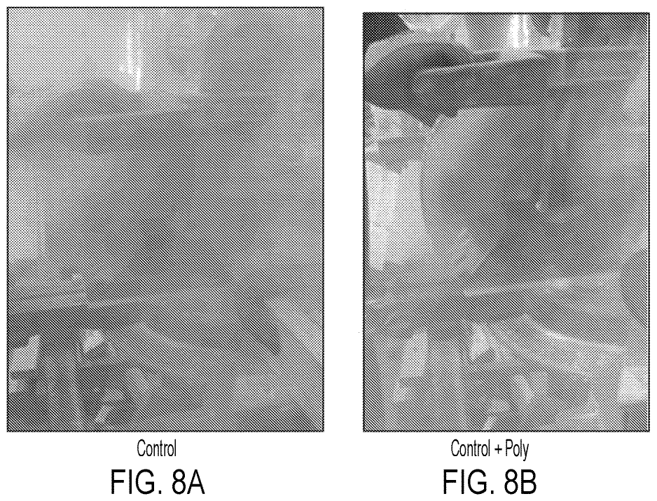

FIGS. 8A and 8B depict a reduction in dust upon cutting boards manufactured in accordance with embodiments herein. FIG. 8A depicts cutting of a gypsum board that was manufactured without the additional polymer in the gypsum core, and FIG. 8B depicts cutting of a gypsum board that was manufactured with the additional polymer in the gypsum core, according to embodiments herein. As can be seen in FIGS. 8A and 8B, the polymer in the gypsum core acts as a binding agent for the gypsum powder and results in less dust spreading from cutting the gypsum board.

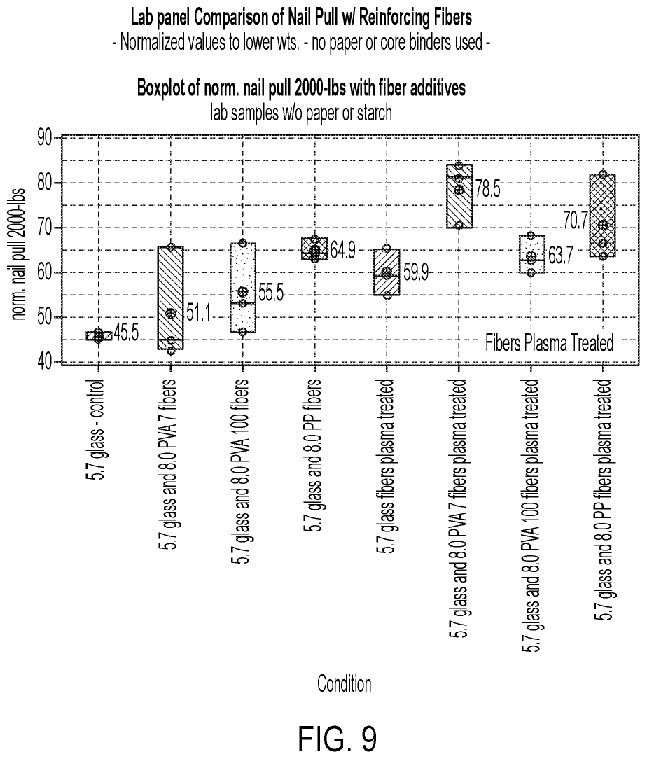

FIG. 9 is a chart depicting comparison of nail pull test results for boards having reinforced fibers, according to various embodiments. The nail pull test is conducted in accordance with the standard test methods for physical testing of gypsum panel products (e.g., ASTM-C473). The nail pull test is conducted by drilling a small pilot hole into the panel under inspection (e.g., a gypsum board). A nail shank attachment is then pushed into the pilot hole, thereby creating crack(s) in the gypsum board or panel; load is recorded until failure.

Introducing fibers into the core of the gypsum board or panel, in accordance with embodiments herein, may require better or improved distribution and better or improved interaction with gypsum molecules. Depending upon the fibers that are introduced, the fibers may be well distributed in the core such as hydrophilic fibers. Fiberglass, PVA and PP can be plasma treated (or corona treatments via bulk drum treater or treatment with surfactants) to improve the gypsum adhesion to fibers in the core thereby mitigating crack propagation. The increase in gypsum adhesion to fibers may increase the ability to prevent shear load related fracturing in the core which occurs in the nail pull test. As shown in FIG. 9, plasma treated fibers resulted in an improvement in nail pull values.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A gypsum board, comprising:
a gypsum layer comprising a gypsum slurry configured to improve one or more of strength, nail pull resistance, pull-through resistance, push-through resistance, flexural strength, compressive strength, or shear strength of the gypsum board,
wherein the gypsum layer comprises a bottom, a top, and a polymeric foam;
a first mat disposed on the bottom of the gypsum layer; and
a second mat disposed on the top of the gypsum layer,
wherein one or more of the gypsum slurry, the first mat, or the second mat comprises reinforced fibers.

2. The gypsum board of claim 1, wherein the gypsum layer further comprises a soap solution.

3. The gypsum board of claim 2, wherein the gypsum slurry comprises polymeric foam and soap solution according to a predetermined mix ratio, wherein the predetermined mix ratio comprises ≥1:1 or 1:≥1, ≥0.1:1 to ≤10:1, ≥0.2:1 to ≤5:1, or ≥0.5:1 to ≤2:1.

4. (canceled)

5. The gypsum board of claim 3, wherein the predetermined mix ratio comprises a polymeric foam solution from 3 to 50% in water and a soap solution of 0.1 to 5% in water, wherein the polymeric foam solution and the soap solution are present in a 1:1 ratio.

6. The gypsum board of claim 5, wherein the gypsum slurry comprises between 0.05 to 15 lbs/msf of polymeric foam.

7. The gypsum board of claim 6, wherein the predetermined mix ratio comprises a polymeric foam solution from 3 to 50% in water and a soap solution of 0.1 to 5% in water, wherein the polymeric foam solution and the soap solution are present in a 1:1 ratio.

8. The gypsum board of claim 7, wherein the gypsum slurry comprises between 0.05 to 15 lbs/msf of polymeric foam.

9. The gypsum board of claim 1, wherein the reinforced fibers comprise one or more of polyamide fibers, polyimide fibers, cellulose fibers, polypropylene fibers, polyethylene fibers, polyvinyl alcohol fibers, hemp fibers, carbon fibers, or glass fibers including glass fibers of the types A, C, E, AE and S.

10. The gypsum board of claim 1, wherein the reinforced fibers comprise at least one of polypropylene fibers and polyamide fibers.

11. (canceled)

12. The gypsum board of claim 11, wherein one or more of the gypsum slurry, the gypsum core, the first mat, or the second mat comprises between 1 to 15 lbs/msf of reinforced fibers.

13. The gypsum board of claim 1, wherein the reinforced fibers comprise plasma-treated or corona-treated reinforced fibers.

14. The gypsum board of claim 1, wherein the polymeric foam comprises styrene butadiene co-polymers, poly-vinyl alcohol, styrene acrylic co-polymers, polymeric microspheres, expandable microspheres, or hollow glass bubbles.

15. The gypsum board of claim 1, wherein the polymeric foam comprises a diluted solution of stryene butadiene co-polymer.

16. The gypsum board of claim 1, further comprising a polymer matrix layer distributed uniformly between the top of the gypsum layer and the second mat.

17. The gypsum board of claim 16, wherein the polymer matrix layer is up to 20 lbs/msf.

18. The gypsum board of claim 1 wherein the gypsum slurry is configured to create a plurality of bubbles on or within the gypsum layer.

19. The gypsum board of claim 1, wherein outer layer is glass mat, coated glass mat or paper or any other facers w/o coating.

20. A method for manufacturing a gypsum board, the method comprising:
forming a gypsum layer from a gypsum slurry, the gypsum layer comprising a gypsum slurry configured to improve one or more of strength, nail pull resistance, pull-through resistance, push-through resistance, or flexural strength of the gypsum board,
positioning a first mat on the bottom of the gypsum layer; and
positioning a second mat on the top of the gypsum layer.

21. A gypsum board comprising:
a gypsum core comprising:
one or more reinforced fibers; and
one or more gypsum layers comprising a soap solution and a gypsum slurry configured to improve one or more of strength, nail pull resistance, pull-through resistance, push-through resistance, or flexural strength of the gypsum board;
a first mat placed on a bottom of the one or more gypsum layers; and
a second mat placed on a top of the one or more gypsum layers.

22-30. (canceled)
